(19) United States
(12) Patent Application Publication
(10) Pub. No.: US 2025/0162113 A1
(43) Pub. Date: May 22, 2025

(54) WORK MACHINE

(71) Applicant: Koki Holdings Co., Ltd., Tokyo (JP)

(72) Inventors: Goya FUJIMOTO, Ibaraki (JP); Shunya SHINTO, Ibaraki (JP); Ryosuke NAKANO, Ibaraki (JP)

(73) Assignee: Koki Holdings Co., Ltd., Tokyo (JP)

(21) Appl. No.: 18/840,072

(22) PCT Filed: Feb. 7, 2023
(86) PCT No.: PCT/JP2023/003914

§ 371 Date: Aug. 20, 2024

(30) Foreign Application Priority Data
Mar. 4, 2022 (JP) 2022-033974

(51) Int. Cl. B25B 23/147; B25F 5/00

(52) U.S. Cl. CPC B25B 23/147; B25F 5/001

(57) ABSTRACT

A work machine has high torque precision. When a prescribed condition pertaining to torque that acts on a tip tool is satisfied during one ON operation of a slide switch (YES in S18 or YES in S19), a microcomputer lowers the duty to d1, which corresponds to a set torque, and sets an effective value for a motor-applied voltage to a completion effective value, which corresponds to a set torque (S25, S13, S14). When a completion condition is satisfied when the duty has been set to d1, the microcomputer sets the effective value for the motor-applied voltage to zero even when the slide switch is in an ON operation, thereby stopping the motor (NO in S20, YES in S21, S25).

### TECHNICAL FIELD

The present invention relates to a work machine such as a driver drill.

### RELATED ART

Patent Document 1 discloses a driver drill that stops a motor when an estimated tightening torque value calculated based on a motor current exceeds a set value.

### RELATED ART DOCUMENTS

### Patent Documents

Patent Document 1: Japanese Patent Application Laid-Open No. 2009-202317

### SUMMARY OF INVENTION

### Problem to be Solved by Invention

Although the method of estimating the tightening torque based on the motor current has the advantage of being capable of simplifying the mechanical configuration, there is a problem that the variation in the tightening torque becomes large.

An objective of the present invention is to provide a work machine with a high torque precision.

### Means for Solving Problem

An aspect of the present invention is a work machine. The work machine includes: a motor; an operation part that switches the motor on and off; a tip tool holding part that holds a tip tool driven by a drive force of the motor; a current detection part that detects a current flowing through the motor; and a control part. The control part is configured to perform drive at a first duty ratio before the current reaches a threshold and perform drive at a constant second duty ratio regardless of a magnitude of the current after the current reaches the threshold, during one on-operation on the operation part.

Another aspect of the present invention is a work machine. The work machine includes: a motor; an operation part that switches the motor on and off; a tip tool holding part that holds a tip tool driven by a drive force of the motor; and a control part that controls drive of the motor. The control part is configured to include a tightening mode, and decrease an effective value of an application voltage applied to the motor to set as a completion effective value, upon satisfaction of a predetermined condition related to a torque acting on the tip tool during one on-operation on the operation part in the tightening mode.

Still another aspect of the present invention is a work machine. The work machine includes: a motor; an operation part that switches the motor on and off; a tip tool holding part that holds a tip tool and is driven by a drive force of the motor; and a control part that controls drive of the motor. The control part is configured to include a tightening mode, and set an effective value of an application voltage applied to the motor as a completion effective value to drive the motor for a predetermined time T1 and then increase the effective value of the application voltage from the completion effective value, upon performance of an on-operation on the operation part in the tightening mode, and is configured to stop the motor even if the operation part is being subjected to the on-operation, upon satisfaction of a completion condition when the effective value of the application voltage is set as the completion effective value.

Still another aspect of the present invention is a work machine. The work machine includes: a motor; an operation part that switches the motor on and off; a tip tool holding part that holds a tip tool and is driven by a drive force of the motor; and a control part that controls drive of the motor. The control part is configured to include a loosening mode, and, in the loosening mode, set an effective value of an application voltage applied to the motor as a start effective value to drive the motor upon performance of an on-operation on the operation part, and increase the effective value of the application voltage from the start effective value when a rotational speed of the motor becomes a predetermined rotational speed X3 or more.

The present invention may be expressed as an “electric work machine”, an “electric tool”, an “electric device”, etc., and those expressed in such terms are also valid as aspects of the present invention.

### Effect of Invention

According to the present invention, a work machine with a high torque precision can be provided.

### BRIEF DESCRIPTION OF DRAWINGS

FIG. 1 is a side cross-sectional view of a work machine 1 according to an embodiment of the present invention.

FIG. 2 is an external view of an operation panel 31 of the work machine 1, showing each of four configuration examples of the operation panel 31.

FIG. 3 is a circuit block diagram of the work machine 1.

FIG. 4 is a control flowchart of a tightening work performed with the work machine 1.

FIG. 5 is a control flowchart of a loosening work performed with the work machine 1.

FIG. 6 is a time chart showing an example of changes over time in a bolt floating amount with respect to a target material, a tightening torque, a motor current, a motor rotational speed, and a duty ratio in the case of performing a bolt tightening work with the work machine 1.

FIG. 7 is a time chart showing an example of changes over time in a screw floating amount with respect to a target material, a tightening torque, a motor current, a motor rotational speed, and a duty ratio in the case of performing a screw tightening work with the work machine 1.

FIG. 8(A) is a time chart showing an example of changes over time in a bolt floating amount with respect to a target material, a tightening torque, a motor current, a motor rotational speed, and a duty ratio in the case of performing a bolt loosening work with the work machine 1. (B) is a time chart showing an example of changes over time in a screw floating amount with respect to a target material, a tightening torque, a motor current, a motor rotational speed, and a duty ratio in the case of performing a screw loosening work with the work machine 1.

### DESCRIPTION OF EMBODIMENTS

In the embodiment, the same or equivalent components, members, etc. shown in each figure will be labeled with the same reference signs, and repeated descriptions thereof will be omitted as appropriate. The embodiment is illustrative and does not limit the invention. Not all features described in the embodiment or combinations thereof necessarily constitute the essence of the invention.

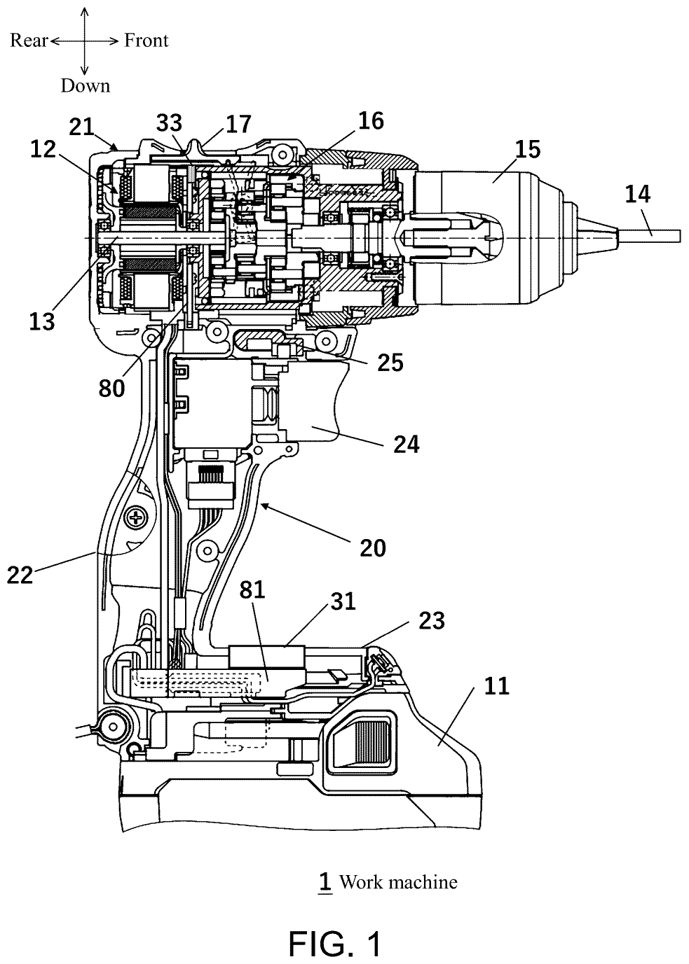

FIG. 1 is a side cross-sectional view of a work machine 1 according to an embodiment of the present invention. A front-rear direction and an up-down direction of the work machine 1 orthogonal to each other are defined based on FIG. 1. The front-rear direction is a direction parallel to a rotation shaft 13. The work machine 1 is a driver drill. The work machine 1 includes a rechargeable battery (secondary battery) 11, and an electric motor (motor) 12 that is rotationally driven with the battery 11 as a power source.

The electric motor 12 (hereinafter referred to as a “motor 12”) includes a rotation shaft 13. The rotation shaft 13 drives (rotates) a tip tool 14 via a planetary gear mechanism (reduction gear) 16. The tip tool 14 is held (fixed) to a keyless chuck 15 serving as a tip tool holding part. By operating the keyless chuck 15, the tip tool 14 may be replaced with a tip tool of another specification such as a driver bit and a hexagon socket.

The work machine 1 includes a housing 20 that forms its outer contour. By injection molding a plastic or the like, the housing 20 is formed into a substantially T shape when viewed from a lateral side. The housing 20 includes a housing body 21 that accommodates the motor 12, a grip part 22, and a battery holding part 23. The grip part 22 extends in a direction intersecting with the rotation shaft 13 (axial direction). Specifically, the grip part 22 extends downward from the housing body 21.

The battery holding part 23 is provided at a lower end of the grip part 22. The battery 11 is mounted to the battery holding part 23 detachably with a one-touch operation. The battery 11 is fixed to the battery holding part 23 by a lock mechanism (not shown). Accordingly, the battery 11 is prevented from falling off from the battery holding part 23 due to vibration or the like.

A slide switch 24, which is capable of moving in the axial direction of the rotation shaft 13, is provided at an upper end of the grip part 22. The slide switch 24 is an operation part that switches on and off (drive and stop) the motor 12. The slide switch 24 is a stepless speed change trigger switch. A rotational speed of the motor 12 is adjusted according to a retraction amount of the slide switch 24. Specifically, the greater the retraction amount is, the higher the rotational speed of the motor 12 becomes.

The work machine 1 includes a forward/reverse switch button 25 on an upper side of the vicinity of the slide switch 24. With the forward/reverse switch button 25, it is possible to switch a rotation direction (forward rotation and reverse rotation) of the motor 12, that is, a rotation direction (forward rotation and reverse rotation) of the tip tool 14.

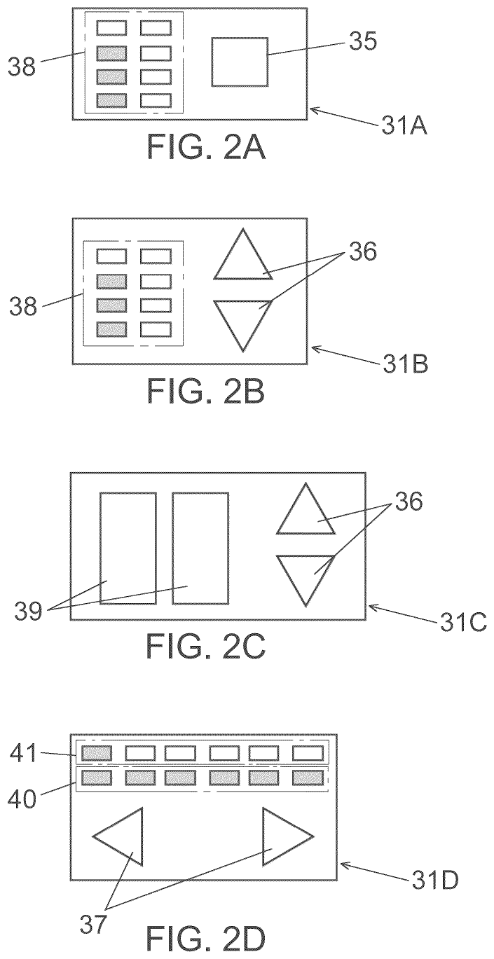

The work machine 1 includes a switching control board 80 inside the housing body 21 and on a front side of the motor 12. The switching control board 80 is mounted with an inverter circuit 82 shown in FIG. 2, and converts a direct current power supplied from the rechargeable battery 11 into an alternating current power to supply the alternating current power to the motor 12. In addition to the inverter circuit 82, a control signal output circuit 83, a magnetic sensor 84, a rotor position detection circuit 85, and a temperature detection circuit 86 shown in FIG. 2 are provided on the switching control board 80.

The work machine 1 includes a main control board 81 in the battery holding part 23. The main control board 81 is mounted with a microcomputer 95 (microcontroller) as a control part shown in FIG. 2, and controls the inverter circuit 82. In addition to the microcomputer 95, a step-down circuit 87, a control system power supply circuit 88, a battery voltage detection circuit 89, an overdischarge detection circuit 90, a current detection circuit 91, a communication circuit 92, and a battery temperature detection circuit 93 shown in FIG. 2 are provided on the main control board 81.

The work machine 1 includes an operation panel 31 on an upper surface of the battery holding part 23. According to an operation on the operation panel 31, an operator is capable of setting a target torque by changing a fixed duty ratio (to be described later).

A Hall IC 33 (magnetic sensor) provided on the switching control board 80 detects a position of a shift knob 17 for changing a gear ratio of the planetary gear mechanism 16, and by learning about a current gear ratio, it is possible to change the fixed duty ratio.

FIG. 2(A) is an external view of an operation panel 31A, which is a first configuration example of the operation panel 31. The operation panel 31A includes a torque setting button 35 as a tightening torque selection part, and a torque display part 38. The torque display part 38 displays a current set torque (selected torque) in eight stages by a light-emitting part such as an LED. Each time the torque setting button 35 is pressed, the set torque (target torque) increases by one stage, and upon pressing the torque setting button 35 when the set torque is at its maximum, the set torque becomes maximum.

FIG. 2(B) is an external view of an operation panel 31B, which is a second configuration example of the operation panel 31. In the operation panel 31B, the torque setting button 35 of the operation panel 31A is replaced with a torque setting button 36. The torque setting button 36 has two types of buttons including a button for increasing the set torque and a button for decreasing the set torque, which makes it possible to increase and decrease the set torque by one stage at a time.

FIG. 2(C) is an external view of an operation panel 31C, which is a third configuration example of the operation panel 31. In the operation panel 31C, the torque display part 38 of the operation panel 31B is replaced with a torque display part 39. The torque display part 39 is capable of digitally display the set torque in up to 99 stages. In addition to increasing and decreasing the set torque by one stage at a time by short pressing the torque setting button 36, it may also be possible to perform quick switching of the set torque by long pressing the torque setting button 36.

FIG. 2(D) is an external view of an operation panel 31D, which is a fourth configuration example of the operation panel 31. The operation panel 31D includes a torque setting button 37 as the tightening torque selection part, a torque display part 40, and a mode display part 41. The torque display part 40 displays a current set torque (selected torque) in six stages by a light-emitting part such as an LED. The torque setting button 37 has two types of buttons including a button for increasing the set torque and a button for decreasing the set torque, which makes it possible to increase and decrease the set torque by one stage at a time.

The mode display part 41 displays a current action mode in six stages. For example, the action mode indicates at least one of, or a combination of two or more of, a set value (500 rpm, 800 rpm, 1000 rpm, 1300 rpm, 1800 rpm, 2000 rpm, etc.) of a rotational speed of the motor 12 in a constant speed control, a setting (M1, M2, M3, M4, M5, M6, etc.) of a band range of the set torque, and a set value of a response (a speed of reaction to an operation of the slide switch 24, a duty ratio increase rate when increasing the rotational speed of the motor 12, etc.). When the action mode indicates the setting of the band range of the set torque, it becomes possible to fine-tune the set torque within the band range by the setting button 37, and the torque display part 40 indicates a magnitude of the set torque within the band range. The action mode may be changed by, for example, long pressing the setting button 37 or by operating an action mode switching button (not shown).

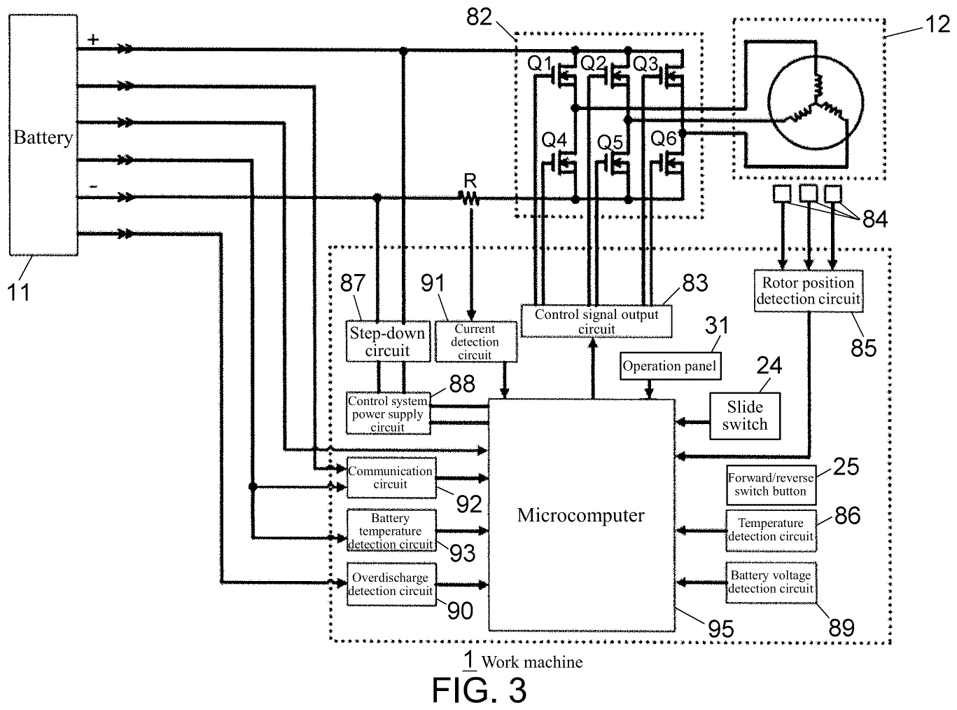

FIG. 3 is a circuit block diagram of the work machine 1. The work machine 1 includes an inverter circuit 82, a control signal output circuit 83, a magnetic sensor 84, a rotor position detection circuit 85, a temperature detection circuit 86, a step-down circuit 87, a control system power supply circuit 88, a battery voltage detection circuit 89, an overdischarge detection circuit 90, a current detection circuit 91, a communication circuit 92, a battery temperature detection circuit 93, and a microcomputer 95.

The inverter circuit 82 includes semiconductor switching elements Q1 to Q6 connected in a three-phase bridge configuration. The inverter circuit 82 converts a direct current power outputted from the battery 11 into an alternating current power for driving the motor 12 and supplies the alternating current power to the motor 12. In accordance with the control of the microcomputer 95, the control signal output circuit 83 applies drive signals, e.g., pulse width modulation (PWM) signals, to each gate of the switching elements Q1 to Q6.

The magnetic sensor 84 detects a magnetic field generated by the rotor of the motor 12 and transmits a signal to the rotor position detection circuit 85. The rotor position detection circuit 85 detects a rotor position of the motor 12 based on the signal from the magnetic sensor 84 and transmits a signal to the microcomputer 95. The temperature detection circuit 86 detects a temperature of the switching elements Q1 to Q6 and transmits a signal to the microcomputer 95.

The step-down circuit 87 reduces an output voltage of the battery 11 and supplies a voltage to the control system power supply circuit 88. The control system power supply circuit 88 converts the output voltage of the step-down circuit 87 into a power supply voltage for the microcomputer 95 and the like and supplies the power supply voltage to the microcomputer 95 and the like. The battery voltage detection circuit 89 detects the output voltage of the battery 11 and transmits a signal to the microcomputer 95.

The overdischarge detection circuit 90 detects an overdischarge notification signal from the battery 11 and transmits a signal to the microcomputer 95. The current detection circuit 91 detects a motor current according to a voltage of a resistor R provided in a path of the current (motor current) flowing through the motor 12, and transmits a signal to the microcomputer 95. The communication circuit 92 is a circuit for communication between the battery 11 and the microcomputer 95. The battery temperature detection circuit 93 detects a temperature notification signal from the battery 11 and transmits a signal to the microcomputer 95.

The microcomputer 95 performs control, e.g., PWM control, on the inverter circuit 82 via the control signal output circuit 83 according to the torque set on the operation panel 31, the rotation direction (hereinafter referred to as a “set rotation direction”) set by the forward/reverse switch button 25, and an operation amount of the slide switch 24, and controls the drive of the motor 12. The microcomputer 95 is capable of controlling an effective value of an application voltage (hereinafter referred to as a “motor application voltage”) applied to the motor 12 according to a duty ratio of the PWM control. The microcomputer 95 turns into a tightening mode when the set rotation direction is forward rotation, and turns into a loosening mode when the set rotation direction is reverse rotation.

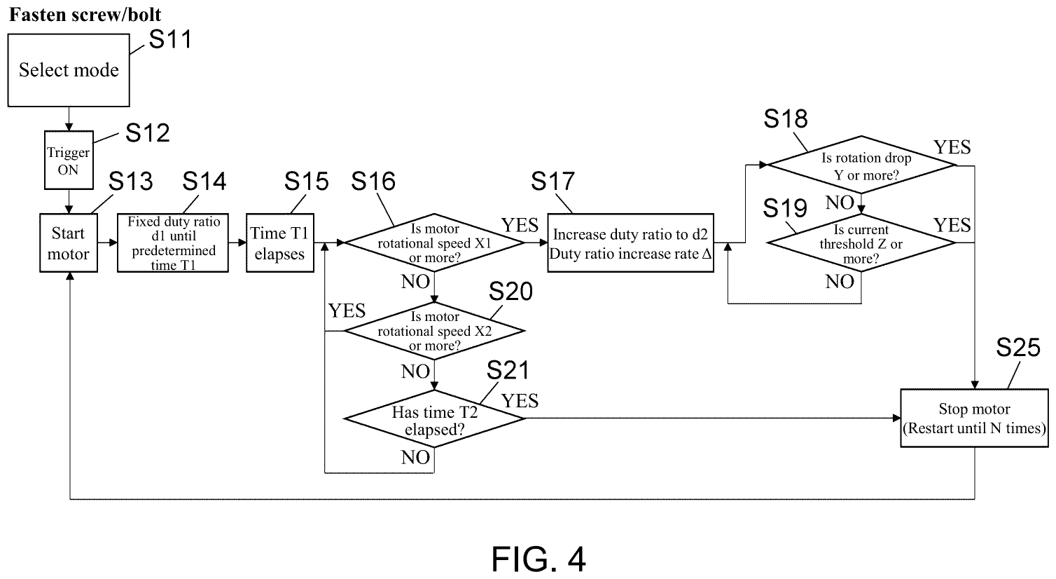

FIG. 4 is a control flowchart of a tightening work performed with the work machine 1. As a premise of this flowchart, the set rotation direction is forward rotation. The operator performs mode selection by operating the operation panel 31 (S11). The mode selection includes setting of the torque and selection of the action mode described above. When the operator turns on the slide switch 24 (S12), the microcomputer 95 starts up the motor 12. In FIG. 4, from S12 onward, it is assumed that the slide switch 24 remains turned on (continuing the on-state).

The microcomputer 95 controls the drive of the motor 12 by fixing, to d1, the duty ratio (hereinafter referred to as a “duty ratio”) of the PWM signals applied to the switching elements Q1 to Q6 of the inverter circuit 82, regardless of the operation amount of the slide switch 24, until a predetermined time T1 has elapsed from turn-on of the slide switch 24 (S14). The predetermined time T1 is, for example, 130 ms. The duty ratio d1 is a value corresponding to the set torque and is, for example, 17.5% or less. The effective value of the motor application voltage in the case of the duty ratio d1 is an example of a completion effective value. The motor 12 driven at the completion effective value automatically stops (locks) upon reaching the set torque.

When the predetermined time T1 has elapsed from turn-on of the slide switch 24 (S15), the microcomputer 95 checks the rotational speed (hereinafter referred to as a “motor rotational speed”) of the motor 12 (S16). In the case where the motor rotational speed is a predetermined rotational speed X1 or more (YES in S16), the microcomputer 95 increases the duty ratio at an increase rate A until d2 (S17). The duty ratio d2 is a value corresponding to a pull amount of the slide switch 24 or a value corresponding to a set value of the rotational speed in the constant speed control. The predetermined rotational speed X1 is, for example, 3,000 rpm. By driving at the fixed duty ratio d1 corresponding to the set torque instead of a duty ratio corresponding to the operation amount of the slide switch 24 during the predetermined time T1 from start-up of the motor 12, since application of a torque at the set torque or more can be suppressed, it is possible to provide a product with a high torque precision.

In the case where a drop in the motor rotational speed in a predetermined measurement time becomes Y or more (YES in S18), that is, in the case where a drop rate of the motor rotational speed becomes a predetermined value or more, or in the case where the motor current becomes a threshold Z or more (YES in S19), the microcomputer 95 stops the motor 12 (S25). At this time, the microcomputer 95 preferably performs a brake control to stop the motor 12 sharply. The brake control is, for example, an electric brake control, specifically, a brake control that turns off all the switching elements Q1 to Q3 and turns on all the switching elements Q4 to Q6. “The drop in the motor rotational speed in the predetermined measurement time being Y or more” and “the motor current being the threshold Z or more” are respectively examples of a predetermined condition related to the torque acting on the tip tool 14.

In the case where the motor rotational speed is not the predetermined rotational speed X1 or more in S16 (NO in S16), if the motor rotational speed is a predetermined rotational speed X2 or more (X2<X1) (YES in S20), the microcomputer 95 returns to S16. The predetermined rotational speed X2 is, for example, 600 rpm. In the case where the motor rotational speed is not the predetermined rotational speed X2 or more in S20 (NO in S20), if the state in which the motor rotational speed is not the predetermined rotational speed X2 or more does not continue for a predetermined time T2 (NO in S21), the microcomputer 95 returns to S16. The predetermined time T2 is, for example, 100 ms. If the state in which the motor rotational speed is not the predetermined rotational speed X2 or more (the state of being less than the predetermined rotational speed X2) continues for the predetermined time T2 in S21 (YES in S21), the microcomputer 95 stops the motor 12 (S25). “The state in which the motor rotational speed is less than the predetermined rotational speed X2 continuing for the predetermined time T2” is an example of a completion condition.

After stopping the motor 12 in S25, the microcomputer 95 returns to S13 and restarts the motor 12 until N times (N is an integer of 1 or more). At the time point of S25, since the tightening has progressed and the torque of the motor 12 has increased, the microcomputer 95 proceeds to NO at the branch in S16 after restarting the motor 12 (S13 after S25). “The restart of the motor 12 (S13) after stopping the motor 12 (S25 after YES in S21) due to continuation for the predetermined time T2 of the state in which the motor rotational speed is less than the predetermined rotational speed X2, and the subsequent stop (S25)”, i.e., a temporary drive control of the motor 12, is an example of a notification control.

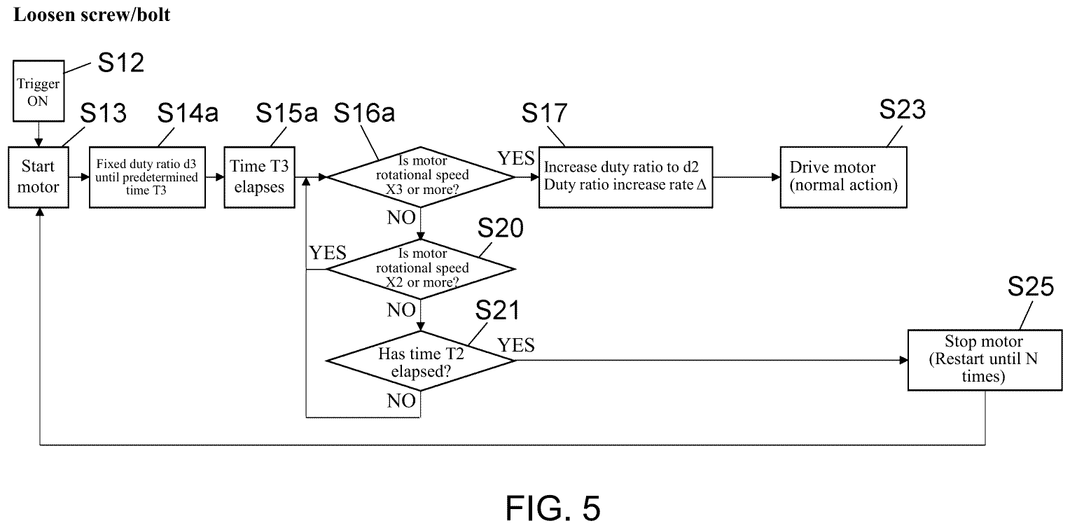

FIG. 5 is a control flowchart of a loosening work performed with the work machine 1. As a premise of this flowchart, the set rotation direction is reverse rotation. In the example of FIG. 5, there is no setting of the torque or selection of the action mode (corresponding to Si 1 in FIG. 4) in the case of reverse rotation. However, it may also be configured to perform setting of the torque or selection of the action mode (corresponding to S11 in FIG. 4) in the case of reverse rotation. When the operator turns on the slide switch 24 (S12), the microcomputer 95 starts up the motor 12. In FIG. 5, from S12 onward, it is assumed that the slide switch 24 remains turned on (continuing the on-state).

The microcomputer 95 controls the drive of the motor 12 by fixing the duty ratio to d3 regardless of the operation amount of the slide switch 24 until a predetermined time T3 has elapsed from turn-on of the slide switch 24 (S14a). The predetermined time T3 may be the same length as the predetermined time T1 described above. The predetermined time T3 is, for example, 150 ms. The duty ratio d3 is set to a value that is the same as or slightly larger than a maximum value of the duty ratio d1 in the case of tightening (the duty ratio d1 in the case where the set torque is maximum). In the case of a configuration of performing setting of the torque also in reverse rotation, the duty ratio d3 is a value corresponding to the set torque. “The effective value of the motor application voltage in the case of the duty ratio d3” is an example of a start effective value.

When the predetermined time T3 has elapsed from turn-on of the slide switch 24 (S15), the microcomputer 95 checks the motor rotational speed (S16a). In the case where the motor rotational speed is a predetermined rotational speed X3 or more (YES in S16), the microcomputer 95 increases the duty ratio to d2 at an increase rate A (S17), and drives the motor 12 at the duty ratio d2 (S23). The predetermined rotational speed X3 may be the same rotational speed as the predetermined rotational speed X1 described above. The predetermined rotational speed X3 is, for example, 3500 rpm. The increase rate A in S17 of FIG. 5 may be different from the increase rate A in S17 of FIG. 4.

In FIG. 5, the flow of the processing in the case of proceeding to NO in S16a is similar to the flow of the processing in the case of proceeding to NO in S16 in FIG. 4.

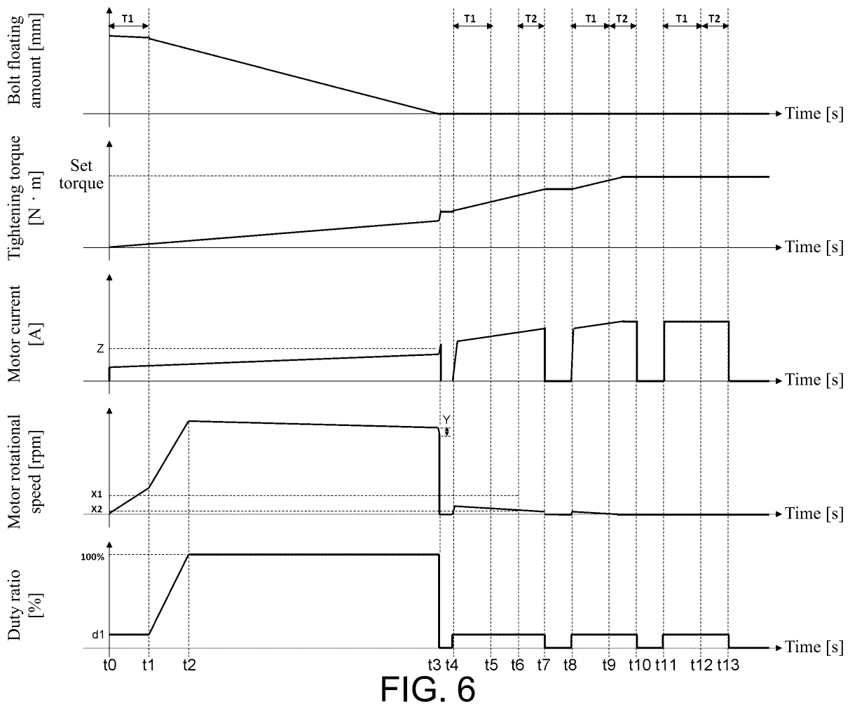

FIG. 6 is a time chart showing an example of changes over time in a bolt floating amount with respect to a target material, a tightening torque, a motor current, a motor rotational speed, and a duty ratio in the case of performing a bolt tightening work with the work machine 1. The target material is a hard component such as metal. In FIG. 6, the number of times to restart the motor 12 (N times in S25 of FIG. 4) is set to three times.

When the slide switch 24 is turned on at time t0, the duty ratio becomes d1, the motor current rises, the tightening torque and the motor rotational speed start to increase, and the bolt floating amount starts to decrease. The slide switch 24 remains turned on (continuing the on-state) after time t0.

During a period from time t0 to time t1 at which the predetermined time T1 has elapsed, the duty ratio is constant at d1. During this period, the motor rotational speed increases above the predetermined rotational speed X1. From time t1 to time t2, the duty ratio increases at the increase rate A, and at time t2, the duty ratio becomes 100% (maximum). Along with this, the motor rotational speed also increases, and the decrease in the bolt floating amount also accelerates. Thereafter, until time t3, the duty ratio is maintained at 100%, the bolt floating amount decreases, the motor current increases along with the increase in the tightening torque, and the motor rotational speed is decreasing.

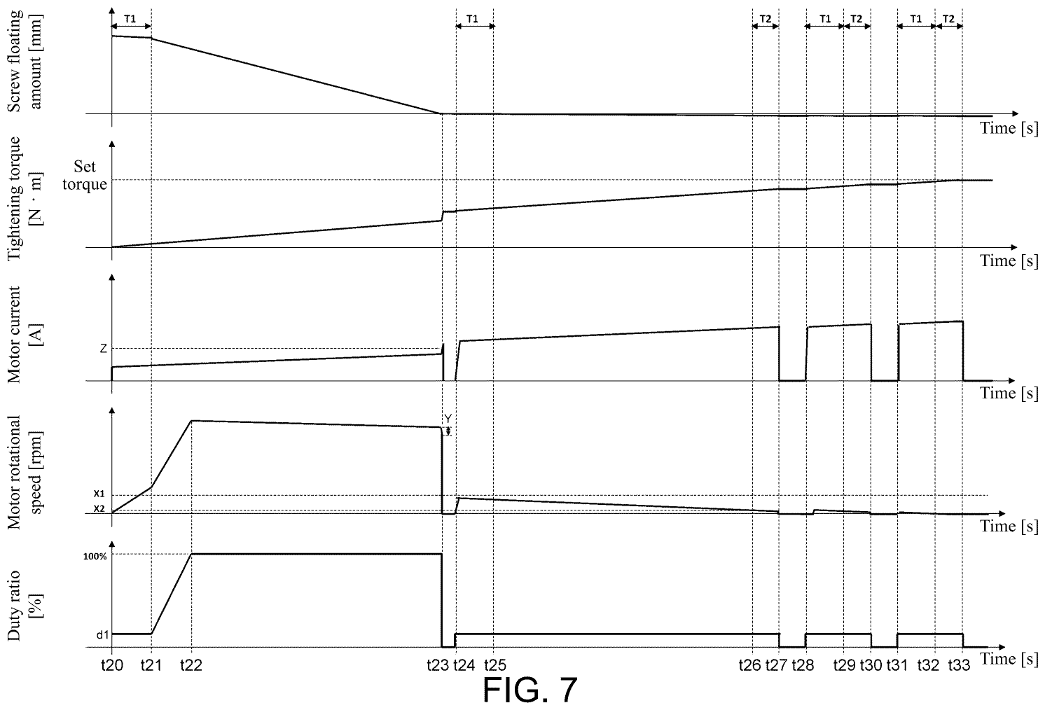

At time t3, the bolt is seated and the tightening torque increases sharply. Accordingly, the drop in the motor rotational speed in the predetermined measurement time becomes Y or more, and the motor current becomes the threshold Z or more. In response to this, the duty ratio decreases to zero all at once, and the motor 12 stops. “The drop in the motor rotational speed in the predetermined measurement time becoming Y or more” and “the motor current becoming the threshold Z or more” are satisfied simultaneously in the examples of FIG. 6 and FIG. 7 (to be described later), but one of them may also be satisfied earlier, and in that case, at the time point at which the one of them is satisfied, the duty ratio decreases to zero and the motor 12 stops.

At time t4 after a predetermined waiting time has elapsed from time t3, the duty ratio becomes d1, the motor current rises again, the motor rotational speed increases again, and the tightening torque increases again. At time t5 at which the predetermined time T1 has elapsed from time t4, the motor rotational speed is the predetermined rotational speed X2 or more. The motor rotational speed becomes less than the predetermined rotational speed X2 at subsequent time t6. At time t7 at which the predetermined time T2 has elapsed from time t6, the duty ratio becomes 0 and the motor 12 stops.

At time t8 after a predetermined waiting time has elapsed from time t7, the duty ratio becomes d1, the motor current rises again, and the tightening torque increases again. At time t9 at which the predetermined time T1 has elapsed from time t8, the motor 12 is rotating at the predetermined rotational speed X2 or less. The duty ratio becomes 0 at time t10 at which the predetermined time T2 has elapsed from time t9. The motor 12 is stopped in the state of the duty ratio d1 between time t9 and time t10. At this time, the tightening torque reaches the set torque.

At time t11 after a predetermined waiting time has elapsed from time t10, the duty ratio becomes d1 and the motor current rises again, but the motor 12 remains stopped and the tightening torque does not increase. The motor current is the same value as the value immediately before time t10. During a period from time t11 to time t12 at which the predetermined time T1 has elapsed, and during a period from time t12 to time t13 at which the predetermined time T2 has elapsed, the same state continues, and the duty ratio becomes 0 at time t13.

FIG. 7 is a time chart showing an example of changes over time in a screw floating amount with respect to a target material, a tightening torque, a motor current, a motor rotational speed, and a duty ratio in the case of performing a screw tightening work with the work machine 1. The target material is a soft component such as a mold. In FIG. 7, the number of times to restart the motor 12 (N times in S25 of FIG. 4) is set to three times.

When the slide switch 24 is turned on at time t20, the duty ratio becomes d1, the motor current rises, the tightening torque and the motor rotational speed start to increase, and the screw floating amount starts to decrease. The slide switch 24 remains turned on (continuing the on-state) from time t20 onward.

From time t20 to time t21 at which the predetermined time T1 has elapsed, the duty ratio is constant at d1. During this period, the motor rotational speed increases above the predetermined rotational speed X1. From time t21 to time t22, the duty ratio increases at the increase rate A, and at time t22, the duty ratio becomes 100% (maximum). Along with this, the motor rotational speed also increases, and the decrease in the screw floating amount also accelerates. Thereafter, until time t23, the duty ratio is maintained at 100%, the screw floating amount decreases, the motor current increases along with the increase in the tightening torque, and the motor rotational speed is decreasing.

At time t23, the screw is seated and the tightening torque increases sharply. Accordingly, the drop in the motor rotational speed in the predetermined measurement time becomes Y or more, and the motor current becomes the threshold Z or more. In response to this, the duty ratio decreases to zero all at once, and the motor 12 stops.

At time t24 after a predetermined waiting time has elapsed from time t23, the duty ratio becomes d1, the motor current rises again, the motor rotational speed increases again, and the tightening torque increases again. At time t25 at which the predetermined time T1 has elapsed from time t24, the motor rotational speed is the predetermined rotational speed X2 or more. At subsequent time t26, the motor rotational speed becomes less than the predetermined rotational speed X2. At time t27 at which the predetermined time T2 has elapsed from time t26, the duty ratio becomes 0 and the motor 12 stops.

At time t28 after a predetermined waiting time has elapsed from time t27, the duty ratio becomes d1, the motor current rises again, the motor rotational speed increases again, and the tightening torque increases again. At time t29 at which the predetermined time T1 has elapsed from time t28, the motor 12 is rotating at the predetermined rotational speed X2 or less. At time t30 at which the predetermined time T2 has elapsed from time t29, the duty ratio becomes 0 and the motor 12 stops.

At time t31 after a predetermined waiting time has elapsed from time t30, the duty ratio becomes d1, the motor current rises again, the motor rotational speed increases again, and the tightening torque increases again. At time t32 at which the predetermined time T1 has elapsed from time t31, the motor 12 is rotating at the predetermined rotational speed X2 or less. At time t33 at which the predetermined time T2 has elapsed from time t32, the duty ratio becomes 0. The motor 12 stops in the state of the duty ratio d1 between time t32 and time t33. At this time, the tightening torque reaches the set torque.

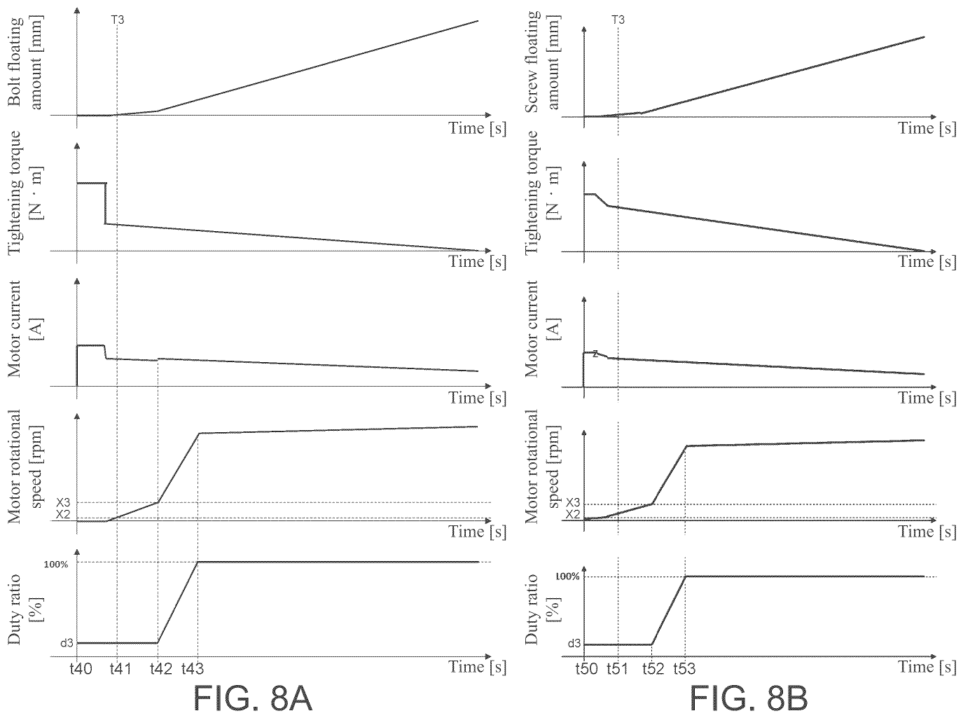

(A) of FIG. 8 is a time chart showing an example of changes over time in a bolt floating amount with respect to a target material, a tightening torque, a motor current, a motor rotational speed, and a duty ratio in the case of performing a bolt loosening work with the work machine 1. The target material is a hard component such as metal.

When the slide switch 24 is turned on at time t40, the duty ratio becomes d1 and the motor current rises. The slide switch 24 remains turned on (continuing the on-state) from time t40 onward.

During a period from time t40 to time t41 at which the predetermined time T3 has elapsed, seating of the bolt is released, the tightening torque decreases sharply, and the motor rotational speed becomes the predetermined rotational speed X2 or more. At time t41, the motor rotational speed is less than the predetermined rotational speed X3.

At subsequent time t42, the motor rotational speed becomes the predetermined rotational speed X3 or more. From time t42 to time t43, the duty ratio increases at the increase rate A, and at time t43, the duty ratio becomes 100% (maximum). Along with this, the motor rotational speed also increases, and the increase in the bolt floating amount also accelerates. Thereafter, the duty ratio is maintained at 100%, the bolt floating amount increases, the motor current decreases along with the decrease in the tightening torque, and the motor rotational speed is increasing.

FIG. 8(B) is a time chart showing an example of changes over time in a screw floating amount with respect a target material, a tightening torque, a motor current, a motor rotational speed, and a duty ratio in the case of performing a screw loosening work with the work machine 1. The target material is a soft component such as a mold.

When the slide switch 24 is turned on at time t50, the duty ratio becomes d1 and the motor current rises. The slide switch 24 remains turned on (continuing the on-state) from time t50 onward.

During a period from time t50 to time t51 at which the predetermined time T3 has elapsed, seating of the screw is released, the tightening torque decreases sharply, and the motor rotational speed becomes the predetermined rotational speed X2 or more. At time t51, the motor rotational speed is less than the predetermined rotational speed X3.

At subsequent time t52, the motor rotational speed becomes the predetermined rotational speed X3 or more. From time t52 to time t53, the duty ratio increases at the increase rate A, and at time t53, the duty ratio becomes 100% (maximum). Along with this, the motor rotational speed also increases, and the increase in the screw floating amount also accelerates. Thereafter, the duty ratio is maintained at 100%, the screw floating amount increases, the motor current decreases along with the decrease in the tightening torque, and the motor rotational speed is increasing.

According to this embodiment, the following effects can be achieved.

(1) The microcomputer 95 is configured such that, in the tightening mode, during one on-operation of the slide switch 24, when a predetermined condition related to the torque acting on the tip tool 14 is satisfied, specifically, when a drop in the motor rotational speed in a predetermined measurement time becomes Y or more or when the motor current becomes a threshold Z or more, the duty ratio is decreased to d1 corresponding to the set torque to set the effective value of the motor application voltage as a completion effective value corresponding to the set torque. Thus, the tightening work is completed in a state in which the effective value of the motor application voltage is the completion effective value and the motor rotational speed is low or zero. Accordingly, the effect caused by the motor rotational speed on the tightening torque can be suppressed to realize a high-precision torque by a duty ratio determined according to a set torque regardless of the motor rotational speed. Herein, for example, at a low duty ratio of 17.5% or less, the control performed by the microcomputer 95 becomes difficult based on current detection, but with torque management performed based on the duty ratio, the control performed by the microcomputer 95 is easy.

(2) The microcomputer 95 is configured such that, when the duty ratio is set to d1, that is, when the effective value of the motor application voltage is set as the completion effective value, if a completion condition is satisfied, even if the slide switch 24 is being subjected to the on-operation, the effective value of the motor application voltage is set to zero to stop the motor 12. Thus, since the motor 12 automatically stops when the completion condition is satisfied, the torque precision is enhanced. Further, the operator does not need to be conscious of the timing to turn off the slide switch 24 for torque adjustment, and operability is good.

(3) The microcomputer 95 sets “a state in which the motor rotational speed is a predetermined rotational speed X2 or less continuing for a predetermined time T2” as the completion condition. Thus, the tightening is completed in a state in which the motor 12 has substantially stopped. Since the lock torque of the motor 12 in a state with a fixed duty ratio is stable, a high-precision torque can be realized.

(4) The microcomputer 95 is configured to perform a notification control according to a temporary drive control on the motor 12 for at least one time after the completion condition is satisfied and the effective value of the motor application voltage is set to zero. Thus, the operator can easily learn that the completion condition has been satisfied, and operability good. The notification control may also be light emission of the operation panel 31 or a light (not shown) or notification based on sound, in place of or in addition to the temporary drive control on the motor 12.

(5) The microcomputer 95 is configured such that, in the tightening mode, when an on-operation is performed on the slide switch 24, the duty ratio is fixed to d1 to set the effective value of the motor application voltage as the completion effective value and drive the motor 12 for a predetermined time T1, and thereafter the duty ratio is increased from d1 to increase the effective value of the motor application voltage from the completion effective value. Herein, for example, in the case of additional tightening (retightening), the completion condition is satisfied during a period from performance of the on-operation on the slide switch 24 until the predetermined time T1 has elapsed, and the microcomputer 95 sets the effective value of the motor application voltage to zero to stop the motor 12 even if the slide switch 24 is being subjected to the on-operation. Thus, a high-precision torque can be realized also in the additional tightening, similar to the case of the normal tightening which is not the additional tightening. On the other hand, in the case of the normal tightening which is not the additional tightening, the completion condition is not satisfied during the period from performance of the on-operation on the slide switch 24 until the predetermined time T1 has elapsed, and the microcomputer 95 increases the duty ratio to increase the motor rotational speed. Thus, compared to the case where the duty ratio remains fixed to d1, high-speed tightening becomes possible, and operability is good.

(6) The microcomputer 95 is configured such that, with a predetermined condition satisfied, that is, with a drop in the motor rotational speed in a predetermined measurement time becoming Y or more, or with the motor current becoming a threshold Z or more, when decreasing the duty ratio to d1 to set the effective value of the motor application voltage as the completion effective value, the duty ratio is temporarily set to 0 to temporarily stop the motor 12, and then the effective value of the motor application voltage is set as the completion effective value. Thus, different from the case where the duty ratio is not temporarily set to zero and the motor 12 is not temporarily stopped, a risk of exceeding the torque can be suppressed during the process of setting the duty ratio to d1, and overtightening can be suppressed to realize a high-precision torque.

(7) The microcomputer 95 is configured such that, in a loosening mode, when an on-operation is performed on the slide switch 24, the duty ratio is fixed to d3 to set the effective value of the motor application voltage as a start effective value and drive the motor 12, and when the motor rotational speed becomes a predetermined rotational speed X3 or more, the duty ratio is increased from d3 to increase the effective value of the motor application voltage from the start effective value. Thus, the reaction at the start of loosening can be suppressed and operability can be improved. That is, if the motor 12 is driven at a high duty ratio from the beginning in the loosening work, it becomes a factor for large swings of reactions, but such a problem can be appropriately solved herein.

Although the embodiment has been described as an example of the present invention, those skilled in the art will understand that various modifications may be made to each component and each processing process of the embodiment within the scope described in the claims. Hereinafter, modification examples will be briefly described.

The description of the embodiment directs to a forward screw that is tightened to the target material when the motor 12 is driven such that the tip tool 14 turns clockwise, but the present invention may also be applied to a reverse screw that is tightened to the target material when the motor 12 is driven such that the tip tool 14 turns counterclockwise. In the case of targeting a reverse screw, the microcomputer 95 turns into the tightening mode when the set rotation direction is reverse rotation, and turns into the loosening mode when the set rotation direction is forward rotation.

The microcomputer 95 may determine that the completion condition has been satisfied immediately when the motor rotational speed becomes the predetermined rotational speed X2 or less. That is, the microcomputer 95 may set “the motor rotational speed being the predetermined rotational speed X2 or less” as the completion condition regardless of the continuation time.

The control of the present invention is not limited to the driver drill illustrated in the embodiment, but may also be applied to, for example, an impact driver or an impact wrench, and in such cases, high-precision torque management also becomes possible.

An acceleration sensor for the rotation direction of the motor 12 may be provided, and the acceleration sensor may detect a rapid decrease in the motor rotational speed (the drop in the motor rotational speed in the predetermined measurement time becoming Y or more).

The specific numerical values exemplified in the embodiment such as the predetermined rotational speed, the predetermined time, the duty ratio, the motor rotational speed, etc. do not limit the scope of the invention in any way and may be changed in any manner according to required specifications.

Reference Signs List

1 Work machine (driver drill), 11 Battery, 12 Electric motor, 13 Rotation shaft,
14 Tip tool, 15 Keyless chuck (tip tool holding part), 16 Planetary gear mechanism, 17
Shift knob, 20 Housing, 21 Housing body, 22 Grip part (handle part), 23 Battery holding
part, 24 Slide switch (operation part), 25 Forward/reverse switch button, 31 Operation
panel, 33 Hall IC, 35 to 37 Torque setting button (tightening torque selection part), 38 to 40
Torque display part, 41 Mode display part, 80 Switching control board, 81 Main control
board, 82 Inverter circuit, 83 Control signal output circuit, 84 Magnetic sensor, 85 Rotor
position detection circuit, 86 Temperature detection circuit, 87 Step-down circuit, 88
Control system power supply circuit, 89 Battery voltage detection circuit, 90 Overdischarge
detection circuit, 91 Current detection circuit, 92 Communication circuit, 93 Battery
temperature detection circuit, 95 Microcomputer.

1. (canceled)

2. (canceled)

3. (canceled)

4. A work machine comprising:
a motor;
an operation part that switches the motor on and off,
a tip tool holding part that holds a tip tool driven by a drive force of the motor; and
a control part that controls drive of the motor, wherein
the control part is configured to comprise a tightening mode, and decrease an effective value of an application voltage applied to the motor to set as a completion effective value regardless of an operation amount of the operation part, upon satisfaction of a predetermined condition related to a torque acting on the tip tool during one on-operation on the operation part in the tightening mode,
the work machine further comprising a tightening torque selection part, wherein
the control part is configured to set the completion effective value according to a selection at the tightening torque selection part,
the control part is configured to set the effective value of the application voltage to zero even if the operation part is being subjected to the on-operation, upon satisfaction of a completion condition when the effective value of the application voltage is set as the completion effective value, and
the completion condition comprises a rotational speed of the motor being less than a predetermined rotational speed.

5. (canceled)

6. (canceled)

7. (canceled)

8. The work machine according to claim 4, wherein the completion condition comprises continuation for a predetermined time of a state in which the rotational speed of the motor is less than the predetermined rotational speed.

9. The work machine according to claim 4, wherein the control part is configured to maintain the application voltage at the completion effective value until the completion condition is satisfied, even if the motor stops when the effective value of the application voltage is set as the completion effective value.

10. The work machine according to claim 4, wherein the control part is configured to perform a notification control after the completion condition is satisfied and the effective value of the application voltage is set to zero.

11. The work machine according to claim 10, wherein the notification control comprises a temporary drive control on the motor.

12. The work machine according to claim 4, wherein the control part is configured to set the effective value of the application voltage as the completion effective value to drive the motor for a predetermined time and then increase the effective value of the application voltage from the completion effective value, upon performance of the on-operation on the operation part in the tightening mode.

13. The work machine according to claim 4, wherein the control part is configured to temporarily stop the motor and then set the effective value of the application voltage as the completion effective value, when decreasing the effective value of the application voltage to set as the completion effective value due to satisfaction of the predetermined condition.

14. The work machine according to claim 4, wherein the predetermined condition comprises a drop rate of the rotational speed of the motor being a predetermined value or more.

15. The work machine according to claim 4, wherein the predetermined condition comprises a current flowing through the motor being a threshold or more.

16. The work machine according to claim 4, wherein the completion effective value is set such that the rotational speed of the motor rises upon application of the completion effective value to the motor after decreasing the effective value of the application voltage applied to the motor.

17. The work machine according to claim 4, wherein the completion effective value is set such that a tightening torque applied to the tip tool holding part when the rotational speed of the motor is less than the predetermined rotational speed becomes higher than a tightening torque applied to the tip tool holding part immediately before the predetermined condition is satisfied.

18. The work machine according to claim 4, wherein the completion effective value is set such that a current flowing through the motor when the rotational speed of the motor is less than the predetermined rotational speed becomes greater than a current flowing through the motor immediately before the predetermined condition is satisfied.

19. The work machine according to claim 10, wherein the notification control comprises restarting the motor by the completion effective value.

20. A work machine comprising:
a motor having a rotation shaft;
a tip tool holding part rotationally driven by the rotation shaft via a reduction gear;
an operation part that switches between drive and stop of the motor;
a tightening torque selection part that selects a set torque; and
a control part that controls drive of the motor,
the work machine being configured as a driver drill that executes a screw tightening work by a tip tool held at the tip tool holding part, wherein
the control part is configured to:
drive the motor to start the screw tightening work upon operation on the operation part;
then drive the motor at a first duty ratio, and temporarily stop drive of the motor before a torque acting on the tip tool holding part reaches the set torque selected by the tightening torque selection part; and
then restart drive of the motor at a constant second duty ratio lower than the first duty ratio, execute the screw tightening work according to the constant second duty ratio until the torque acting on the tip tool holding part reaches the set torque selected by the tightening torque selection part, stop the motor when the torque acting on the tip tool holding part reaches the set torque, and maintaining stop of the motor until an operation driving the motor is executed again by the operation part.

21. The work machine according to claim 20, wherein the control part is configured to execute temporary stop of the motor and restart of drive of the motor according to the constant second duty ratio multiple times, until the torque acting on the tip tool holding part reaches the set torque.
